(19) United States
(12) Patent Application Publication
(10) Pub. No.: US 2013/0309027 A1
(43) Pub. Date: Nov. 21, 2013

(54) Cutting Insert and Tool for Chip Removal

(71) Applicant: Sergey Chistyakov, Nahariya (IL)

(72) Inventor: Sergey Chistyakov, Nahariya (IL)

(73) Assignee: Iscar, Ltd., Tefen (IL)

(21) Appl. No.: 13/474,356

(22) Filed: May 17, 2012

(51) Int. Cl. B23B 27/16; B23C 5/22

(52) U.S. Cl. 407/102; 407/114

(57) ABSTRACT

A cutting tool assembly includes a cutting insert and tool configured for holding the cutting insert. The cutting insert includes an insert mounting portion and at least one cutting portion projecting therefrom. The cutting insert is shaped to allow the at least one cutting portion to project outwardly from the tool, when mounted thereon, while the remainder of the cutting insert is located within a boundary of the tool in an end view thereof.

### FIELD OF THE INVENTION

The subject matter of the present application relates to a cutting insert configured for chip removal from metal workpieces and a tool therefor, and in particular a cutting insert and tool having a design for unimpeded chip evacuation from a workpiece.

### BACKGROUND OF THE INVENTION

Chip-removal machining of metal workpieces is often accomplished with cutting inserts which are removably secured to a tool.

A significant consideration in design of such cutting inserts and tools in chip-removal machining is facilitating evacuation of chips which have been removed from a workpiece. It will be appreciated that chip-evacuation is further complicated in internal machining operations such as boring and internal threading, since an often significant volume of an interior of the workpiece being machined is occupied by the cutting insert and tool.

### SUMMARY OF THE INVENTION

The subject matter of the present application is directed to cutting assemblies comprising cutting inserts and tools which can have advantageous mounting portions and/or cutting portions. While such designs may be advantageous for any number of applications, it will be understood that specific advantages may be possible for internal cutting operations, particularly those carried out in space constricted areas.

In accordance with a first aspect of the subject matter of the present application, there is provided a cutting insert which comprises a solid insert mounting portion or hub. The solid insert mounting portion can comprise an insert anchoring arrangement comprising adjacent first and second insert anchoring surfaces extending transversely relative to each other and to an insert base surface of the insert anchoring arrangement.

In accordance with another aspect of the subject matter of the present application, there is provided a cutting insert comprising an insert mounting portion, and a cutting portion projecting from the insert mounting portion; the cutting portion comprising a cutting edge extending between a rake surface and at least one relief surface; the insert mounting portion being solid and comprising an insert anchoring arrangement; the insert anchoring arrangement comprising an insert base surface, and first and second insert anchoring surfaces which are adjacent to each other and extend transversely to each other and to the insert base surface.

For the purposes of the specification and claims:
A mounting portion of a cutting insert is a portion thereof that comprises an abutment surface intended or configured for abutment with a tool (i.e. anchoring surfaces and base surfaces).
A cutting portion is considered to “project” from an insert basic body or mounting portion when it has a periphery which is separate from an abutment surface. For example a corner of a standard rectangular shaped insert would not be considered to be projecting from the mounting portion thereof, if the cutting insert comprises a base surface extending substantially underneath the corner and intended to be mounted on a tool thereby. A cutting portion in accordance with any of the aspects of the present application could be defined as a “cutting finger”.

In accordance with a still further aspect of the subject matter of the present application, there is provided a cutting insert comprising an insert mounting portion or hub, and a plurality of cutting portions which project from the insert mounting portion and which can be non-parallel with each other and/or the cutting portions can be contoured. Such construction can possibly reduce a magnitude of at least one dimension of the cutting insert.

For example, in accordance with yet another aspect of the subject matter of the present application, there is provided a cutting insert comprising a plurality of non-parallel cutting portions which each project from an insert mounting portion; each cutting portion comprising a cutting edge extending between a rake surface and at least one relief surface; wherein the at least one relief surface is contoured such that, with the exception of one of the cutting portions, the remainder of the cutting insert is shaped to remain within a periphery of regular volumetric shape.

For the purposes of the specification and claims, a regular volumetric shape is defined as any three dimensional shape having a cross section thereof, taken perpendicular to a main axis of the shape (for example a longitudinal axis, in the case of an elongated volumetric shape, such as a cylinder), which is bounded by a regular shape such as a circle, ellipse, square, rectangle, etc.

In accordance with still another aspect of the subject matter of the present application, there is provided a cutting insert having an insert plane which is parallel to a largest imaginary circle that circumscribes the cutting insert, the cutting insert comprising an insert mounting portion, and a plurality of non-parallel cutting portions, each of which projects from the insert mounting portion and comprises a cutting edge extending between a rake surface and at least one relief surface; wherein each rake surface is slanted relative to the insert plane.

For the purposes of the specification and claims, the term “slanted” means non-parallel and non-perpendicular.

In accordance with another aspect of the subject matter of the present application, there is provided an indexable cutting insert comprising: an insert mounting portion defining an insert base plane and having an insert central axis perpendicular to the insert plane; and a plurality of cutting portions projecting in a generally radially outward direction from the insert mounting portion, when viewed along the insert central axis, each cutting portion comprising a cutting edge formed at an intersection of a rake surface and relief surface; wherein each cutting edge and/or each rake surface is slanted relative to the insert base plane.

In accordance with still another aspect of the subject matter of the present application, there is provided a tool comprising: a clamping arrangement, a tool anchoring arrangement, and an insert pocket comprising a neck portion located between the clamping arrangement and the tool anchoring arrangement, and first and second pocket portions which are located on opposite sides of, and expand from, the neck portion.

In accordance with another aspect of the subject matter of the present application, there is provided a tool comprising: a clamping arrangement, a tool anchoring arrangement located in the center of the tool, and an insert pocket located at least partially between the clamping arrangement and the tool anchoring arrangement; wherein the tool anchoring arrangement comprises a tool base surface and first and second insert anchoring surfaces extending transversely relative to each other and the tool base surface, and wherein the tool base surface extends slanted relative to a first tool plane extending longitudinally through the tool, and a second tool plane perpendicular to the first tool plane.

For the purposes of the specification and claims an element being located in the “center” of or “centrally” relative to another element means that it is not located along the periphery of such element. However the term “middle” implies a precise location coinciding with a center point of an element.

In accordance with still another aspect of the subject matter of the present application, there is provided a tool assembly comprising, in combination, an insert and tool according to any one of the previous aspects.

In accordance with an aspect of the subject matter of the present application, there is provided a tool assembly comprising: a cutting insert comprising an insert mounting portion and a plurality of cutting portions projecting from the insert mounting portion, and a tool configured to hold the cutting insert; the tool comprising a clamping arrangement, and an insert pocket formed at, at least, a central portion of the tool; and wherein, in an end view of the tool assembly when the cutting insert is mounted in the insert pocket, exactly one of the plurality of cutting portions of the cutting insert is the only part of the cutting insert to project from a periphery of the tool.

In accordance with yet another aspect of the subject matter of the present application, there is provided a tool assembly comprising: a cutting insert, and a tool configured to hold the cutting insert; wherein an imaginary circle circumscribing a largest dimension of the cutting insert has an insert diameter larger than a tool dimension taken along a cross section of the tool which is perpendicular to an end view of the tool; and wherein the cutting insert is mounted in the insert pocket such that in an end view of the tool assembly, a single cutting portion of the cutting insert is the only part of the cutting insert projecting from the tool.

It will be understood that the subject matter of the present application relates to a cutting insert and tool which each have multiple separately inventive aspects, but any or each of the aspects could also be part of a single cutting insert or tool as will be elaborated below.

Possible advantages of some features of the subject matter of the present application may include:
A solid mounting portion, i.e. free of voids such as a bore or aperture (which could be configured to receive a clamp), possibly providing a compact shape.
Transverse anchoring surfaces, which could also be described as being wedge-shaped, possibly providing stable mounting of a cutting insert to a tool. More precisely, such arrangement can allow ease of mounting and removal of a cutting insert to a tool (allowing sliding and guided motion along the insert anchoring surfaces until the insert base surface, transverse to the anchoring surfaces, arrests further motion). Additionally, such arrangement may provide suitable restriction of movement, in particular rotational movement, of the cutting insert in an operative mounted position.
The cutting portions can be oriented and/or shaped to reduce the overall dimension(s) of the cutting insert.

It will also be understood that the above-said is a summary, and that any of the aspects above may further comprise any of the features described in connection with any of the other aspects or described hereinbelow. For example, the following features may be applicable to any of the above aspects of the present application:
i. A cutting insert can be an indexable cutting insert. The cutting insert can be indexable about an insert central axis.
ii. The cutting insert can be rotationally symmetric about the insert central axis.
iii. An insert anchoring arrangement can further comprise a top surface which is located opposite to an insert base surface.
iv. An insert base surface can be flat. A first insert anchoring surface and/or a second insert anchoring surface can be flat.
v. A first insert anchoring surface and a second insert anchoring surface can form an external angle of between 40° to 140°, or, preferably, between 60° to 120°. In some embodiments it may be particularly advantageous for first and second insert anchoring surfaces to extend at a right angle to each other.
vi. A downward direction can be defined, for example, from an insert top surface towards an insert base surface. An inward direction can be defined, for example, as a direction towards an insert central axis which extends through a center point of a cutting insert. More precisely, an insert central axis can extend through insert top and base surfaces and through a center point of a cutting insert. An outward direction can be defined, for example, as a direction which is not towards the insert central axis.
vii. A first insert anchoring surface can extend in a downward or downward-inward direction. A first insert anchoring surface can be perpendicular to an insert base surface.
viii. A second insert anchoring surface can extend in a downward-outward direction.
ix. A cutting insert can comprise an insert biasing portion. An insert biasing portion can be spaced apart from an insert anchoring arrangement. An insert biasing portion can extend from an insert top surface in a downward-outward direction. An insert biasing portion can be concavely shaped.
x. A cutting insert can comprise a second or additional insert anchoring arrangement. In such case, an insert biasing portion can extend between an insert top surface and a first insert anchoring surface of the additional insert anchoring arrangement. A cutting insert can comprise a plurality of insert anchoring arrangements. A cutting insert can comprise exactly three insert anchoring arrangements.
xi. A cutting edge can be non-parallel and/or non-perpendicular with an insert base surface.
xii. An insert mounting portion can have rotational symmetry about an insert central axis.
xiii. A volume periphery can be curved. A volume periphery can have an elliptical or circular cross section.
xiv. At least one cutting portion or each cutting portion can have at least two differently located and/or shaped contoured relief surfaces. In such case a contoured relief surface of one cutting portion can be configured to complement a different contoured relief surface of another cutting portion for remaining with a volume periphery.
xv. At least one cutting portion or each cutting portion can be asymmetric. To clarify, such asymmetry includes views from any perspective.
xvi. Each of the at least one relief surfaces can converge to form a ridge opposite an associated rake surface.
xvii. At least one or each cutting portion comprises opposite and non-symmetric first and second lateral relief surfaces.
xviii. A first lateral relief surface can be coplanar with an insert base surface of a cutting insert.
xix. A second lateral relief surface can comprise a first sub-relief surface extending from rake face at a first angle, and a second sub-relief surface extending at a more inward orientation than the first sub-relief surface.
xx. At least one or each cutting portion can comprise a contoured corner relief surface located at an intersection of an end relief surface and a second lateral relief surface.
xxi. A mounting portion can comprise a plurality of cutting portions respectively extending from a plurality of spaced-apart lateral projections of the mounting portion, and a circumscribed circle touching outermost points of the cutting portions can have a radius which is smaller than a length of a longest cutting portion of the cutting portions, i.e. measured from a center point of the mounting portion to an outermost point of the longest cutting portion. It will be understood that the name “longest cutting portion” can also refer to more than one cutting portion in a case where there are a plurality of longest cutting portions or they are all the same length.
xxii. At least one or each cutting portion can be elongated.
xxiii. A mounting portion can comprise a plurality of insert mounting projections. Each cutting portion projecting from an associated mounting projection can form a bend therewith.
xxiv. At least one or each cutting portion can project in a generally radially outward direction from the insert mounting portion.
xxv. At least one or each cutting portion can be twisted or curved.
xxvi. At least one or each cutting portion can comprise contoured relief surfaces.
xxvii. At least one or each rake face can be slanted relative to an insert base plane. At least one or each rake face can be slanted at a common angle to an insert base plane.
xxviii. The rake surfaces can all be non-parallel or non-planar to each other.
xxix. In one or both of a plan or end view of a rake surface of a cutting portion, the cutting insert can be non-planar along planes parallel and perpendicular to the rake surface viewed. More precisely, the cutting insert can be curved.
xxx. At least one or each cutting edge can be slanted relative to an insert base surface or insert base plane. At least one or each cutting edge face can be slanted at a common angle to an insert base plane.
xxxi. The cutting edges of different cutting portions can all be non-parallel or non-planar (i.e. not lying on the same plane) to each other. Thus, the cutting edges can be skewed relative to every other cutting edge (of a different cutting portion).
xxxii. Any of the features above attributed to the cutting edge could alternatively refer to one or more sub-edges thereof, e.g. only a front cutting edge or only a front cutting edge and one of two side edges, etc. For example, the front edges can be skewed to each other front edge.
xxxiii. In a Cartesian coordinate system, when a first one of cutting portions projects parallel with, and in a positive direction along, a z-axis:
   a second cutting portion can project in the negative direction of the x-axis, and
   a third cutting portion can project in the positive direction of the x-axis.
xxxiv. In a Cartesian coordinate system, when one of cutting portions projects parallel with, and in a positive direction along, a z-axis:
   another cutting portion can project in the negative direction of each of the x, y and z axes; and/or
   another cutting portion can project in the positive direction of the x and y axes and the negative direction of the z-axis.
xxxv. When x and y directions of a Cartesian coordinate system can be defined along a rake surface of one of the cutting portions, the other cutting portions can extend in each of the x, y and z directions of a Cartesian plane.
xxxvi. In a Cartesian coordinate system, when a first one of cutting portions projects parallel with, and in a positive direction along, a z-axis:
   one of the other cutting portions extends at least in a positive directions of an axis which is not the z-axis, and another of the other cutting portions extends at least in a negative directions of the same axis.
xxxvii. Any of the arrangements described in connection with a Cartesian coordinate system can be fulfilled when the cutting portion which extends in a positive direction along the z-axis, extends only in that direction and not along any other axis.
xxxviii. Any of the arrangements described in connection with a Cartesian coordinate system can be fulfilled when the cutting portion which extends in a positive direction along the z-axis, extends only in that direction and each other cutting portion does not extend along the negative direction of the z-axis. More precisely, each other cutting portion does not extend along the negative direction of the z-axis in the same view. Even more precisely, each other cutting portion does not extend along only the negative direction of the z-axis.
xxxix. Any of the arrangements described in connection with a Cartesian coordinate system can be fulfilled in a plan or end or side rake surface view or any combination of these views. For example, any of the arrangements above can be true in a plan, side and end rake surface view of one of the cutting portions.
xl. A tool anchoring arrangement can comprise a tool base surface, and first and second insert anchoring surfaces extending transversely relative to each other and to the tool base surface.
xli. A first tool insert anchoring surface can comprise a first edge shared with a second tool anchoring surface and the first and second tool anchoring surfaces together can form a wedge-shaped corner.
xlii. A tool anchoring arrangement can extend axially along the tool further outward from the tool than a clamping arrangement and is thereby configured to guide a cutting insert from the first and second insert anchoring surfaces to a tool base surface.
xliii. An insert pocket can comprise first and second pocket portions which extend in different axial directions along a longitudinal axis of the tool.
xliv. A tool can comprise a tool guard portion extending tangentially along a periphery of the tool and forming a boundary of one of the pocket portions.
xlv. A tool base surface can extend slanted relative to a first tool plane extending longitudinally through the tool, and a second tool plane perpendicular to the first tool plane.
xlvi. A tool can extend forwardly from a shank end to a head end and a tool base surface can be slanted in a forward-outward direction.
xlvii. A clamping arrangement can be configured to apply a force towards a tool anchoring arrangement and/or a tool base surface.
xlviii. The first and second pocket portions can be located at opposite sides of the tool.
xlix. Wherein the insert pocket extends through a center of the tool. In some embodiments the insert pocket can extend through a center point of the tool and a longitudinal tool axis extending through the middle of the tool can intersects the insert pocket.
l. The above mentioned locations of the insert pocket can be relative to an end view of the tool.
li. An imaginary circle circumscribing a largest dimension of the cutting insert can have a diameter larger than a dimension taken along a cross section of the tool in an end view thereof. An insert base plane can be parallel to a largest imaginary circle that circumscribes the cutting insert
lii. The cutting insert can only abut the tool base surface and first and second anchoring surfaces.
liii. An active cutting portion (i.e. the cutting portion which projects from the tool when mounted therein) can protrude axially from the tool. Such construction may assist in allowing unimpeded axially directed movement of a tool assembly.

### BRIEF DESCRIPTION OF THE DRAWINGS

For a better understanding of the subject matter of the present application, and to show how the same may be carried out in practice, reference will now be made to the accompanying drawings, in which:

FIG. 1A is a first rear perspective view of a tool assembly;

FIG. 1B is a front perspective view of the tool assembly in FIG. 1A;

FIG. 1C is a second rear perspective view of the tool assembly in FIGS. 1A and 1B, taken from an alternative side to the view shown in FIG. 1A;

FIG. 1D is a side view of the tool assembly in FIGS. 1A to 1C;

FIG. 1E is a side view of the tool assembly in FIG. 1D rotated 90°;

FIG. 1F is a side view of the tool assembly in FIG. 1D rotated 180°;

FIG. 1G is a side view of the tool assembly in FIG. 1D rotated 270°;

FIG. 1H is a rear view of the tool assembly in FIGS. 1A to 1G;

FIG. 1I is a front view of the tool assembly in FIGS. 1A to 1H, and a workpiece;

FIG. 2A is a plan view of a top surface of a cutting insert of the tool assembly in FIGS. 1A to 1I, which is also a view that is perpendicular to an insert plane along which a maximum dimension of the cutting insert can be measured;

FIG. 2B is a side view of the cutting insert in FIG. 2A, which is also a view that is parallel to the insert plane;

FIG. 2C is a plan view of a rake surface of the cutting insert in FIGS. 2A and 2B;

FIG. 2D is a side view of the rake surface in FIG. 2C, i.e. rotated 90° from FIG. 2C around the z axis;

FIG. 2E is a bottom view of the cutting insert in FIG. 2C i.e. rotated 180° from FIG. 2C around the z axis;

FIG. 2F is an end view of the rake surface in FIG. 2C, i.e. rotated 90° from FIG. 2D around the y axis;

FIG. 3A is a front perspective view of a tool of the tool assembly in FIGS. 1A to 1I;

FIG. 3B is a side view of the tool in FIG. 3A;

FIG. 3C is a side view of the tool in FIG. 3B rotated 90°;

FIG. 3D is a side view of the tool in FIG. 3B rotated 180°;

FIG. 3E is a front view of the tool in FIGS. 3A to 3D;

FIG. 4A is a schematic perspective view of a tool assembly and workpiece;

FIG. 4B is a schematic side view of the tool assembly and workpiece in FIG. 4A;

FIG. 5A is a rear perspective view of a tool assembly;

FIG. 5B is a front perspective view of the tool assembly in FIG. 5A;

FIG. 5C is a front view of the tool assembly in FIGS. 5A and 5B;

FIG. 5D is a side view of the tool assembly in FIGS. 5A to 5C;

FIG. 6A is a side view of a tool of the tool assembly in FIGS. 5A to 5D;

FIG. 6B is a side perspective view of the tool in FIG. 6A;

FIG. 7A is a side perspective view of a cutting insert of the tool assembly in FIGS. 5A to 5D;

FIG. 7B is a side view of the cutting insert in FIG. 7A; and

FIG. 7C is a front view of the cutting insert in FIGS. 7A and 7B.

### DETAILED DESCRIPTION

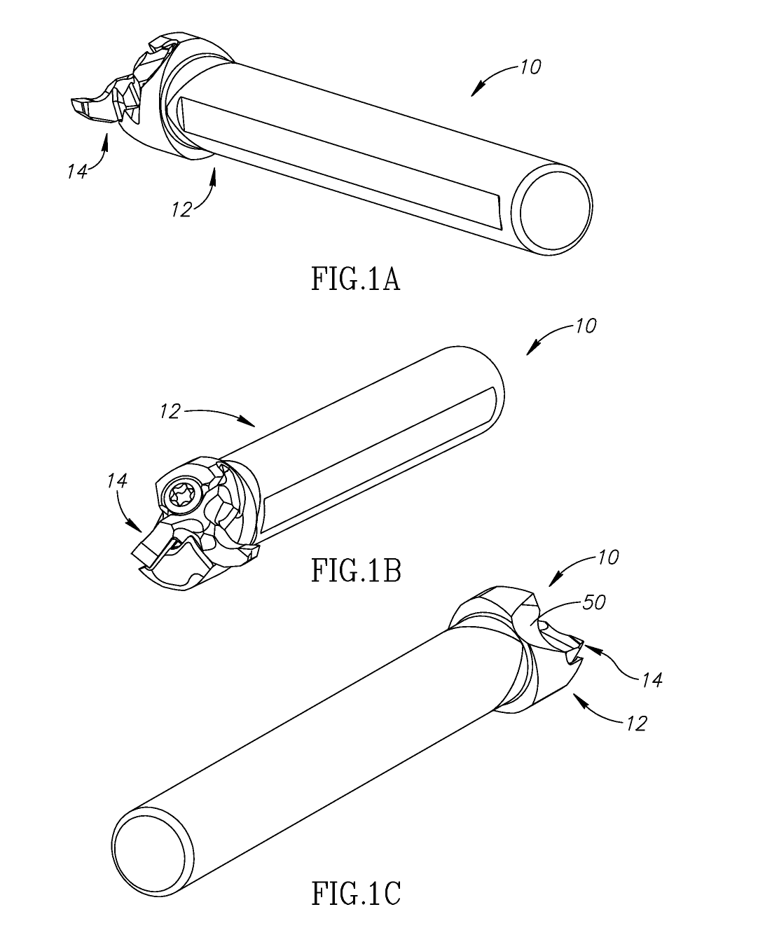

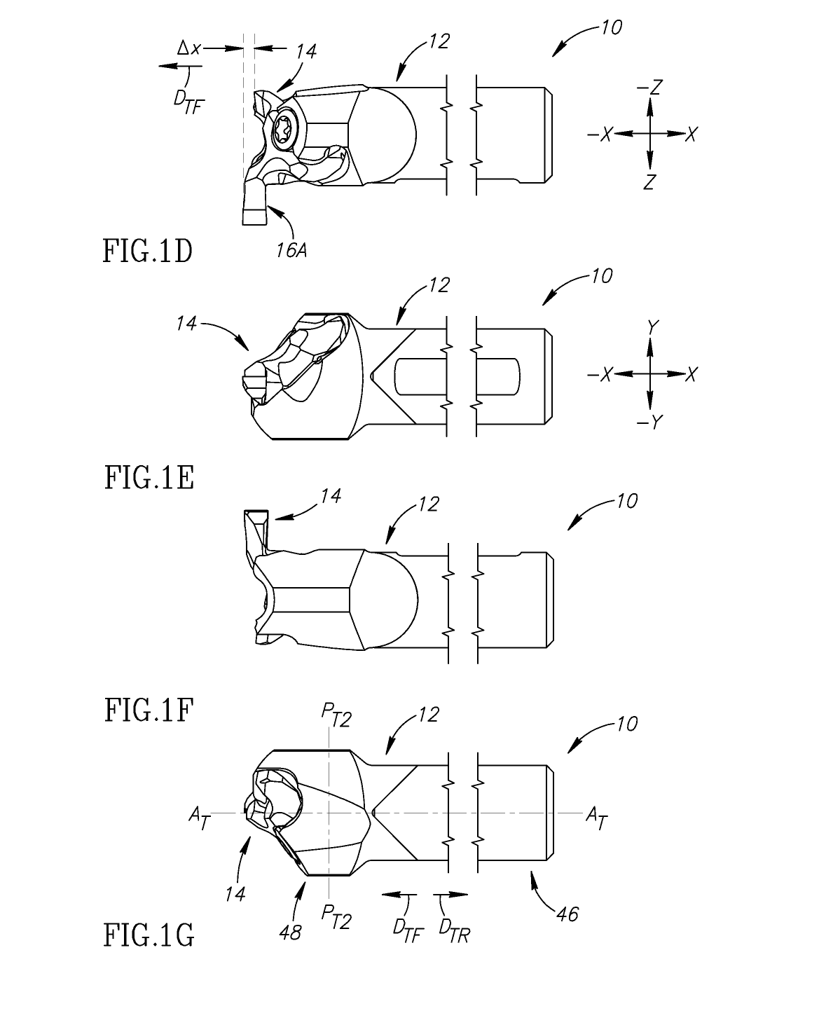

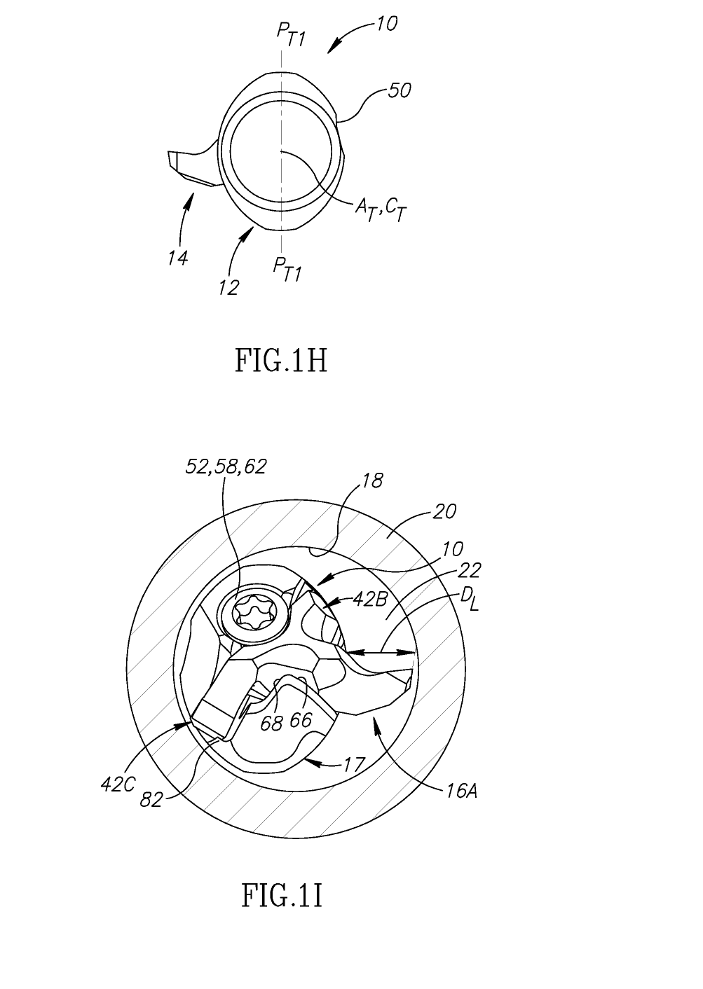

Referring to FIGS. 1A to 1I, there is shown a tool assembly 10 comprising a tool 12 and a cutting insert 14 secured to the tool 12.

A general explanation regarding operation of the tool assembly 10 can be understood with reference to FIG. 1I. To elaborate, constructional features of the tool assembly 10, allow the cutting insert 14 to be mounted to the tool 12 such that only a single cutting portion 16A of the tool 12 projects outwardly, by a distance D_{L}, from a periphery 17 of the tool 12. One possible advantage being that the tool assembly 10 can be inserted into a relatively small bore 18 of a workpiece 20, whilst still being capable of having a relatively long cutting depth C_{D} and even leaving a significant evacuation volume 22 of the bore 18 unoccupied to allow chips (not shown) passage thereout. Such configuration may be particularly advantageous for non-rotating tools of the type shown, however could also be conceivably used for rotating tools.

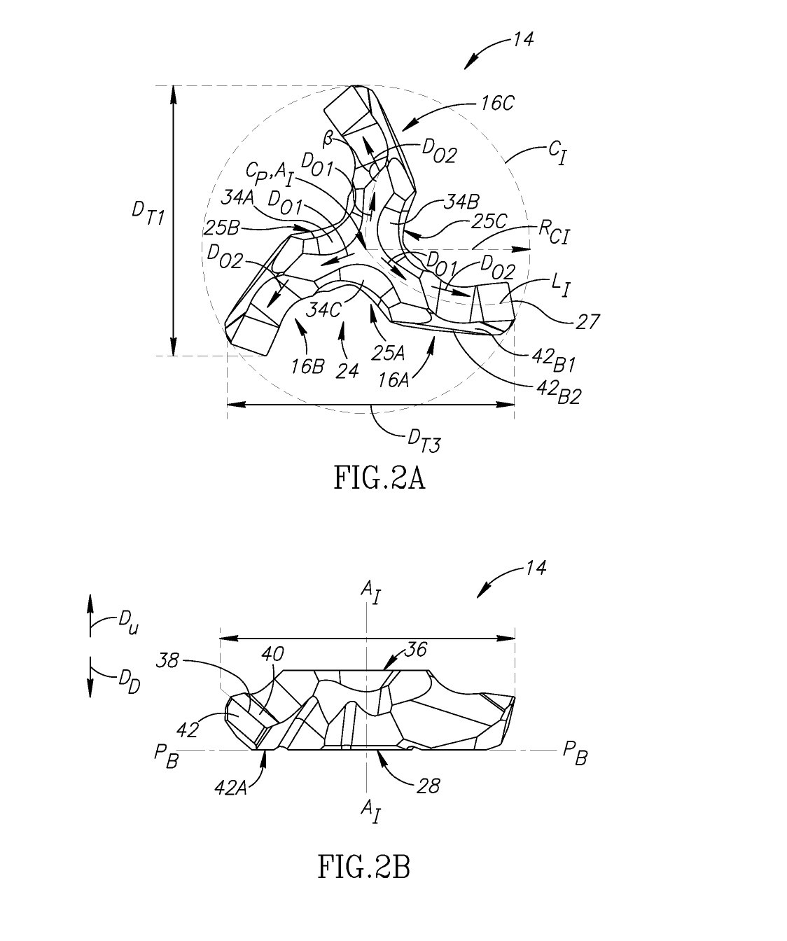

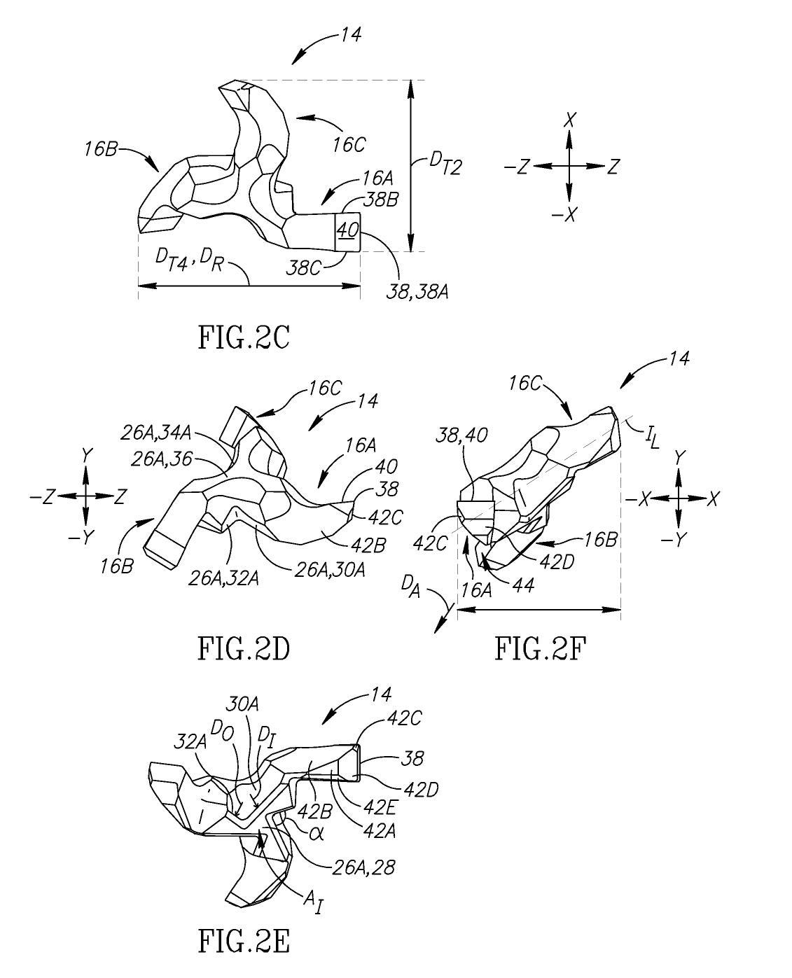

Referring to FIGS. 2A to 2F, specific exemplary features of the cutting insert 14 will be described.

The cutting insert 14 can typically be made of extremely hard and wear-resistant material such as cemented carbide, either by form-pressing and then sintering carbide powders in a binder or by powder injection molding methods. The latter method can be preferred for some embodiments which are configured for space-confined internal cutting operations.

The cutting insert 14 comprises an insert mounting portion 24 and can comprise, for example, three cutting portions 16A, 16B, 16C which project from, in this non-limiting example, mounting projections 25A, 25B, 25C (FIG. 2A) of the mounting portion 24. As seen in the plan view of the top surface of the cutting insert (FIG. 2A), the cutting portions 16A, 16B, 16C may be curved as they project from the insert mounting portion 24 in a generally radially outward direction relative to an insert central axis A_{I}.

The mounting portion 24 can be solid, i.e. free of a hole or aperture. The mounting portion 24 comprises all surfaces configured for mounting the cutting insert 14 to the tool 12. Stated differently, the mounting portion 24 can comprise one or more insert anchoring arrangements 26A, 26B, 26C.

Each anchoring arrangement can be identical and, for example, a first insert anchoring arrangement 26A can comprise an insert base surface 28 (FIG. 2E), first and second insert anchoring surfaces 30A, 32A, an insert biasing portion 34A, and an insert top surface 36 (FIG. 2D).

The insert base and top surfaces 28, 36 can be opposite each other, and can be commonly shared by each of the insert anchoring arrangements 26A, 26B, 26C.

The insert base surface 28 can be flat and can lie along an insert base plane P_{B} (FIG. 2B). It will be understood that a flat base surface 28 can, in some embodiments, be useful for mounting and/or production of a cutting insert 14.

The cutting insert 14 can have a center point C_{P} through which the insert central axis A_{I} passes. The insert central axis A_{I} can extend in a direction perpendicular to the insert base surface 28, and can also be perpendicular to the insert base plane P_{B}. In embodiments where the top surface 36 is flat, the insert central axis A_{I} can extend in a direction perpendicular thereto.

The cutting insert 14 can be indexable about the insert central axis A_{I}. The cutting insert 14 can be rotationally symmetric about the insert central axis A_{I}. In particular, the cutting insert 14 can be rotationally symmetric in accordance with the condition: 360°/(number of cutting portions).

An upward direction D_{U} (FIG. 2B) can be defined as being parallel to the insert central axis A_{I} and extending from the insert base surface 28 towards the insert top surface 36 (represented by the arrow designated D_{U}). A downward direction D_{D} can be in an opposite direction to the upward direction D_{U}.

Referring to FIG. 2E, an inward direction D_{I} can be defined as a direction towards the insert central axis A_{I}, and an outward direction D_{O} can be defined in a direction away therefrom.

The first insert anchoring surface 30A can extend in a downward direction D_{D} and, at least partially, in an inward direction D_{I}. Stated differently, the first insert anchoring surface 30A can be slanted in a downward-inward direction. The inward slant component of the first insert anchoring surface 30A can be very small such that the first insert anchoring surface 30A can even be perpendicular, or substantially perpendicular, to the insert base surface 28.

The second insert anchoring surface 32A can extend in a downward direction D_{D} and in an outward direction D_{O}.

The first and second insert anchoring surfaces 30A, 32A can be adjacent, and transversely extending, to each other and can extend transversely to the insert base surface 28. The first and second insert anchoring surfaces 30A, 32A can be flat. An insert anchoring surface angle a which is an external angle formed between the first and second insert anchoring surfaces 30A, 32A, can be between 40° to 140°, or, preferably, between 60° to 120°. In this non-limiting example the insert anchoring surfaces can extend at a right angle to each other.

The insert biasing portion 34A can be spaced apart from, or located on an opposite side of the mounting portion 24, the first and second insert anchoring surfaces 30A, 32A. The insert biasing portion 34A can extend from the insert top surface 36 in a downward-outward direction D_{D}, D_{O}. The insert biasing portion 34A can be concavely shaped.

Each of the insert anchoring arrangements 26A, 26B, 26C can have a similar or identical construction to that described above in connection with the first insert anchoring arrangement 26A. For example, the three biasing portions 34A, 34B, 34C are identified in FIG. 2A, etc.

Referring to FIG. 2A, the mounting projections 25A, 25B, 25C project in first outward directions D_{O1}. The cutting portions 16A, 16B, 16C also project outwardly from the mounting projections 25A, 25B, 25C in second outward directions D_{O2} which form an obtuse angle β with the first outward directions D_{O1}. The change in direction provides each associated mounting projection and cutting portion (e.g. 25A and 16A) with a bent shape.

It will be understood that if the cutting portions 16A, 16B, 16C would extend in the same direction as the mounting projections 25A, 25B, 25C, the insert circumscribed circle C_{I}, which can extend parallel to the insert base plane P_{B} and can touch outermost points of the cutting insert 14, would have a larger radius R_{CI}.

Stated differently, the radius R_{CI} is smaller than a magnitude of length L_{I} measured along the dotted line L_{D} (FIG. 2A) which extends from the center point C_{P} to an outermost point 27 of the longest cutting portion.

The cutting portions 16A, 16B, 16C can be elongated for desired applications, for example when a large depth of cut is required.

Referring to FIGS. 2C to 2F, as the cutting portions 16A, 16B, 16C are identical only the first cutting portion 16A will be described in detail.

The first cutting portion 16A comprises a cutting edge 38 which extends between a rake surface 40 (over which chips, not shown, flow) and at least one relief surface 42. More precisely, referring only to FIG. 2C, the cutting edge 38 can comprise a front edge 38A, and first and second side edges 38B, 38C extending therefrom.

The front edge 38A can extend perpendicular to an associated cutting portion (in this example, it can extend perpendicular to the first cutting portion 16A, i.e. it can extend parallel to the x-axis in FIG. 2C). The front edge 38A can be straight. The front edge 38A can be coplanar with the rake surface 40.

Either or both of the side edges 38B, 38C can:
extend parallel to an associated cutting portion (in this example, they can extend parallel to the first cutting portion 16A, i.e. they can extend parallel to the z-axis in FIG. 2C); and/or
can be straight; and/or
can be coplanar with an associated rake surface.

As shown best in FIG. 2B, the rake surface 40 is non-parallel and/or non-perpendicular with an insert base surface 28. More precisely, the rake surface 40 is rotated or slanted about two axes relative to the insert base surface 28, as will be explained hereinafter. Each of the rake surfaces 40 can be slanted or non-parallel relative to the other rake surfaces. Similarly, each cutting edge 38 can be slanted relative to the insert base surface 28. Additionally, each cutting edge 38 can be slanted or non-parallel with the other cutting edges 38.

The at least one relief surface 42 can comprise contoured surfaces to configure the cutting insert 14 to remain within the tool's periphery 17, as shown in FIG. 1I. More precisely, referring to FIGS. 2B and 2E, the at least one relief surface 42 can comprise a first lateral relief surface 42A, which can be coplanar with an insert base surface 28, a second lateral relief surface 42B extending from the rake surface 40, a corner relief surface 42C located at an intersection of an end relief surface 42D and the second lateral relief surface 42C, and a third lateral relief surface 42E extending from the rake surface 40.

Referring to FIG. 2A, the second lateral relief surface 42B can comprise a first sub-relief surface 42B1 extending from rake face 40 at a first angle and a second sub-relief surface 42B2 extending at a more inward orientation than the first sub-relief surface 42B 1.

Each of the relief surfaces can converge to form a ridge 44 (FIG. 2F) opposite an associated rake surface 40.

As best shown in FIG. 1I, the relief surfaces, in this view the second lateral relief surface 42B and the corner relief surface 42C have been contoured or shaped to correspond to the periphery 17 of the tool. Stated differently, the relief surfaces can be configured to be contained within a volume, which in this example is elongated and has an oval or elliptical cross section in an end view or cross section thereof.

As shown, for example in FIG. 1A, the cutting portions 16A, 16B, 16C can be configured to complete the volume of a tool to which they are mounted. In any case, the cutting insert 14 and/or cutting portions 16A, 16B, 16C thereof, can be configured to not protrude from a tool cross section, which could prevent access of the tool assembly 10 to some constricted spaces.

It will be understood, that in addition to providing the cutting insert 14 with a bent shape (best shown in FIG. 2F), and providing non-parallel cutting portions 16, and bending the cutting portions 16 from a projection direction of the mounting projections 25, mounting orientation of the cutting insert 14 can also further compact the cutting insert 16 in an end view (at least for the cutting application exemplified).

Drawing attention to FIGS. 2C to 2F, a Cartesian coordinate system is used to explain the three-dimensional design of the cutting insert 14.

Using the first cutting portion 16A as a reference, it is noted that the first cutting portion 16A extends parallel with, and in a positive direction along, a z-axis.

In such case, the second cutting portion 16B can project in the negative direction of each of the x, y and z axes.

The third cutting portion 16C can project in the positive direction of the x and y axes and the negative direction of the z-axis.

Accordingly, it will be understood that lengthening the cutting portions will not increase the radial dimension D_{R} (FIG. 2C) by the same magnitude. Accordingly, the cutting insert 14 may be configured with a greater depth of cut than a comparative insert with the same sized circumscribing circle.

It will also be understood that to reach the rake surface 40 position shown in FIG. 2F (i.e. with the rake surface 40 facing an upward or positive y-axis direction) from a largest dimension orientation shown in FIG. 2A, the cutting insert 14, using the first cutting portion 16A as a reference, can be first rotated about the z-axis to reduce a first transverse dimension D_{T1} thereof to a second transverse dimension D_{T2} which has a smaller magnitude along the x-axis.

The cutting insert 14 can also be rotated about the x-axis to reduce a third transverse dimension D_{T3} thereof, measured perpendicular to the first transverse dimension D_{T1}, to a fourth transverse dimension D_{T4} having a smaller magnitude along the z-axis.

It is also noted that in each of the views of the rake surface 40, namely the plan view in FIG. 2C, the side view in FIG. 2D and the end view in FIG. 2F:
the central axis A_{I} of the cutting insert 14 is neither perpendicular to the plane of the page (in contrast to FIG. 2A) nor does it lie in the plane of the page (in contrast to FIG. 2B);
the cutting insert 14 is considered not to be planar in the sense that it does not extend along a straight line in the two dimensional figures (for example, in FIG. 2F, using as a reference an imaginary line I_{L} which is drawn along the middle of cutting portions 16A and 16C, it is shown that cutting portion 16B extends in a direction D_{A} which is non-parallel with the imaginary line I_{L}); and
the second and third cutting portions 16B and 16C extend in positive and negative directions of an axis other than the z-axis along which the first cutting portion 16A extends.

Drawing attention to FIGS. 1G and 1H, the tool 12 comprises a center point C_{T}, a longitudinal tool axis A_{T} which extends through the center point C_{T}, a first tool plane P_{T1} which bisects the tool 12 and coincides with the tool axis A_{T}, and a second tool plane P_{T2} which extends perpendicular to the first tool plane P_{T1}.

More precisely, the tool 12 can comprises a shank 46 and a head 48 which is forwardly axially located of the shank 46.

It will be understood that the second tool plane P_{T2}, can extend through the tool's head 48, and that any dimension of the tool 12, taken along the second tool plane P_{T2}, can be smaller in magnitude to at least one dimension of the cutting insert 14 taken along the insert base plane P_{B}.

Arrows showing a rearward axial direction D_{TR} and forward axial direction D_{TF}, both of which are parallel with the longitudinal tool axis A_{T}, are shown in FIG. 1G.

The head 48 can be formed with a chip evacuation recess 50.

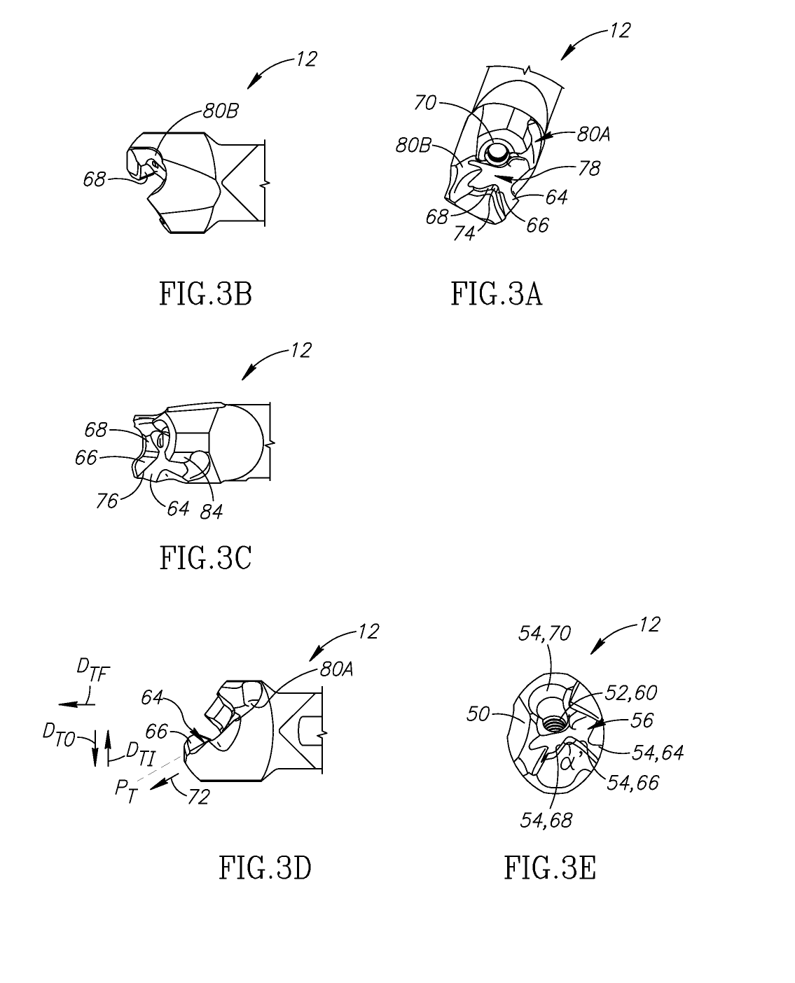

Referring to FIGS. 1I and 3E, the head 48 can comprise a clamping arrangement 52, a tool anchoring arrangement 54 and an insert pocket 56.

The clamping arrangement 52 can comprise, for example, a screw 58 and a threaded screw hole 60 configured for receiving the screw 58.

The screw 58 can comprise a head portion 62 and a threaded shaft portion (not shown) configured for connection to the threaded screw hole 60.

The clamping arrangement 52 can be configured to apply a force towards the tool anchoring arrangement 54 and/or a tool base surface 64 thereof.

The tool anchoring arrangement 54 can comprise all tool surfaces configured for mounting the cutting insert 14 to the tool 12.

More precisely, the tool anchoring arrangement 54 can comprise the tool base surface 64 (FIG. 2E), first and second tool anchoring surfaces 66, 68 and a tool biasing portion 70 (FIG. 3E).

Locations and/or orientations of the tool base surface 64, and first and second tool anchoring surfaces 66, 68 can be configured to correspond to the surfaces of the insert anchoring arrangement 26, mutatis mutandis.

Any or all of the tool anchoring arrangement 54 surfaces can be located in the center of the tool 12, as shown in FIG. 3E. Stated differently, the tool anchoring arrangement 54 can be in a location other than along a periphery of the tool 12.

The tool base surface 64 can be flat and can lie along a tool base plane P_{T} (FIG. 3D).

The tool base surface 64 can extend slanted relative to the first tool plane P_{T1} and the second tool plane P_{T2}. Such slant can be considered a forward-outward direction (D_{TF}, D_{TO}; a tool outward direction being defined as a direction away from the longitudinal tool axis A_{T}, and a tool inward direction D_{TI} being defined as opposite to the tool outward direction D_{TO}) shown by arrow 72 in FIG. 3D.

The first tool anchoring surface 66 can extend in a tool forward direction D_{TF} and, at least partially, in a tool outward direction D_{TO}. Stated differently, the first tool anchoring surface 66 can be slanted in a forward-outward direction.

The second tool anchoring surface 68 can extend in a tool forward direction D_{TF} and in a tool inward direction D_{TI}.

The first and second tool anchoring surfaces 66, 68 can be adjacent, and transversely extending, to each other and can extend transversely to the tool base surface 64.

The first and second tool anchoring surfaces 66, 68 can share a first anchoring surface common edge 74 (FIG. 3A). The first tool anchoring surfaces 66 and the tool base surface 64 can share a second anchoring surface common edge 76 (FIG. 3C).

The first and second tool anchoring surfaces 66, 68 can be flat. A tool anchoring surface angle α′ (FIG. 3E) which is an internal angle formed between the first and second tool anchoring surfaces 66, 68 can be between 40° to 140°, or, preferably, between 60° to 120°. In this non-limiting example the tool anchoring surfaces can extend at a right angle to each other.

Referring to FIG. 3A, the tool biasing portion 70 can be spaced apart from the first and second tool anchoring surfaces 66, 68. Stated differently the tool biasing portion 70 can be located on an opposite side of the insert pocket 56, or, more, precisely, a neck portion 78 thereof, from the first and second tool anchoring surfaces 66, 68. The insert biasing portion 34A can be concavely shaped.

The insert pocket 56 can comprise the neck portion 78 and first and second pocket portions 80A, 80B which are located on opposite sides of, and can expand from, the neck portion 78.

The first and second pocket portions 80A, 80B can be oriented and/or extend in directions and/or have similar dimension (e.g. elongated, curved, etc.) to correspond to the orientations/directions/shapes described above in connection with the insert cutting portions, mutatis mutandis.

Additionally, the insert pocket 56 can comprise tool guard portions 82, 84 (FIGS. 1I and 3C) extending tangentially along a periphery of the tool and forming a boundary of a respective one of the pocket portions 80A, 80B.

In operation, the cutting insert 14 can be mounted on the tool 12 by bringing the anchoring surfaces 30A, 32A, 66, 68 into contact and sliding the cutting insert 14 therealong until the insert base surface 28 contacts the tool base surface 64. The screw 58 can then be rotated to abut the head portion 62 thereof against the tool biasing portion 70, which can secure the anchoring surfaces 30A, 32A, 66, 68 and base surfaces 28, 64 against each other.

To remove the cutting insert 14 from the tool 12, advantageously, the screw 58 need not be removed completely from the tool 12, but can be slightly retracted from the tool enough to allow the cutting insert 14 to be slidingly removed.

Numerous advantages can be possibly provided from such clamping arrangement, for example:
repeatability of positioning (for example, caused by the clamping arrangement 52 directly forcing the cutting insert 14 into the wedge arrangement formed by the anchoring surfaces 30A, 32A, 66, 68; or, for example, by there being no bore in the cutting insert 14 allowing movement of a screw 58 therein; stated differently, the cutting insert 14 can be wedged between the wedge-shaped tool anchoring surfaces 66, 68, and the screw 58 which in turn is wedged securely against the concave tool biasing portion 70; stated differently still, the cutting insert 14 is held between integral material of the tool's head 48 on both sides thereof);
repeatability of positioning (for example, forces applied on the cutting insert 14 during a cutting operation are not in a removal direction of the screw, reducing stress, damage and movement of the screw)
stable clamping (for example, caused by the wedge arrangement being inclined such that the clamping arrangement 52 forces the cutting insert 14 into the tool 12, consequently the cutting insert 14 is not held to the tool 12 only by a screw 58 but primarily by integrally formed portions of the tool 52;
stable clamping (for example, caused by the wedge arrangement being inclined such that when cutting forces are applied on cutting portion 16A in a direction normal to the rake surface 40, the incline or slant of the first tool anchoring surface 66 and/or the tool base surface 64 can also force the cutting insert 14 into the tool 12); stated differently, during a cutting operation the forces on the cutting insert 14 can increase mounting strength;
chip evacuation (for example, due to the non-active cutting portions 16B, 16C being within the periphery of the tool 12, allowing space for chips to be evacuated therepast);
maintenance of non-active cutting portions (for example, as the non-active cutting portions 16B, 16C can be within the periphery of the tool 12, and can also be protected by the tool guard portions 82, 84, from chips, they are to a degree protected from chips; such protection can also allow a cutting insert to be used to its theoretical maximum cutting depth);
uninhibited axial movement (for example, as the cutting insert 14 is configured to protrude an axial distance Δx, FIG. 1D, past the tool 12, the tool can be operated such that it does not abut an object in the forward axial direction D_{TF});
increased depth of cut (for example, elongating the cutting portions does not enlarge the cutting insert 14, at least in an end view of, for example, the rake surface 40 thereof, in an equal ratio); and
independently operative cutting portions (for example, as each cutting portion projects from a hub or mounting portion with projections, and possibly assisted by elongation of the cutting portions, it has been found that even when a given cutting portion is disconnected from the insert during another cutting operation, the remainder of the cutting insert 14 can remain intact and the remaining cutting portions remain useable).

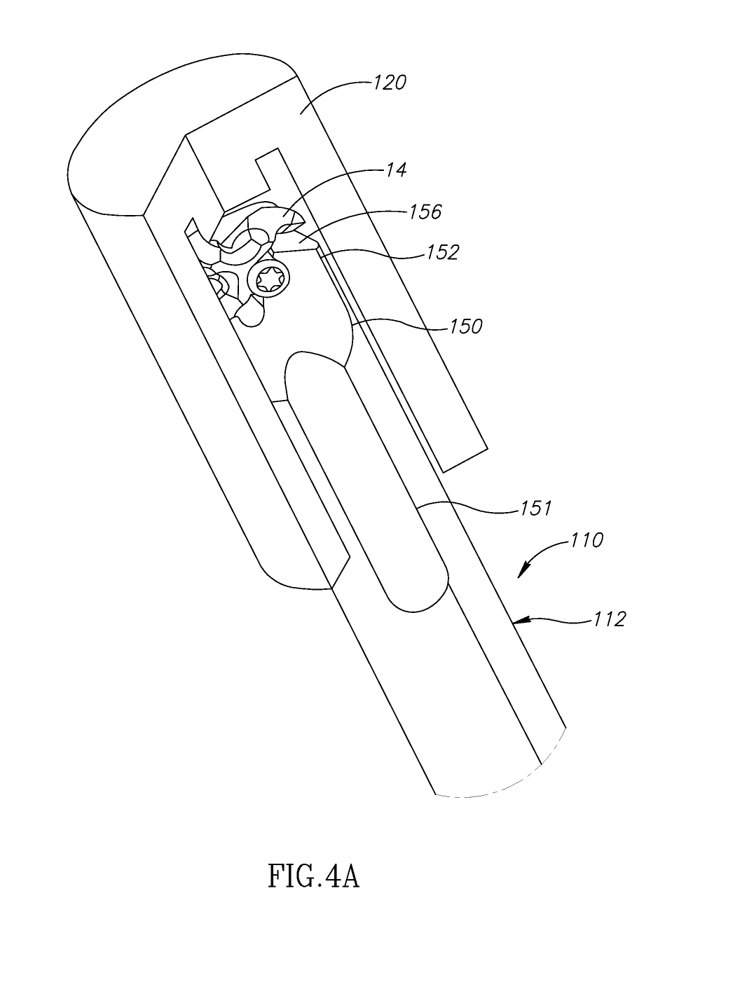

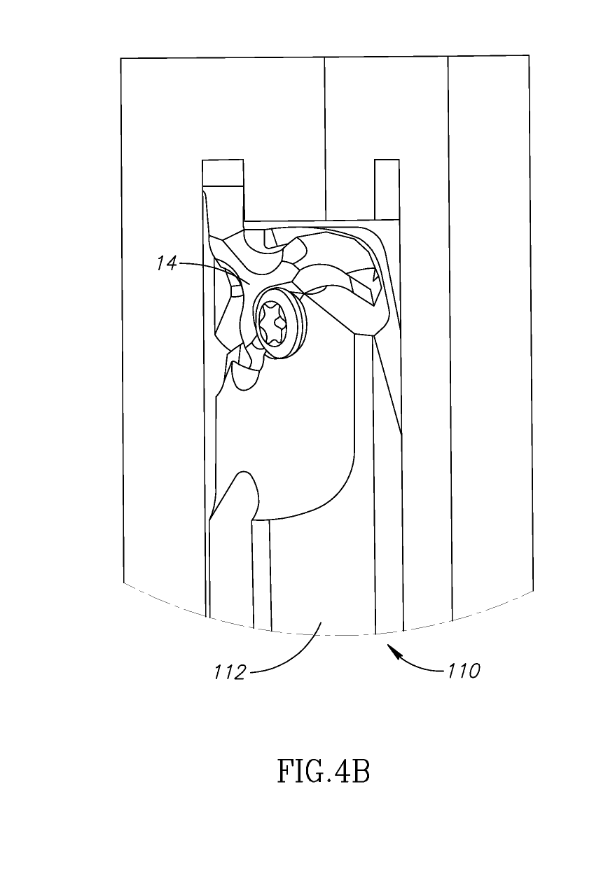

Drawing attention to FIGS. 4A and 4B, a further tool assembly 110 is shown, with elements similar to those mentioned above in connection with tool assembly 10, albeit having reference numerals shifted by 100.

Tool assembly 110 exemplifies that the cutting insert 14 previously described can be mounted in a different tool 112 and be used to cut a workpiece 120 in an axial direction rather than a radial direction.

The clamping arrangement 152, tool anchoring arrangement (not shown) and insert pocket 156 are identical to that described above, with only the portion of the head which comprises them being rotated, so to speak, relative to the tool's shank.

A further, merely optional change, being an addition of an elongated auxiliary evacuation recess 151 extending from the head's evacuation recess 150.

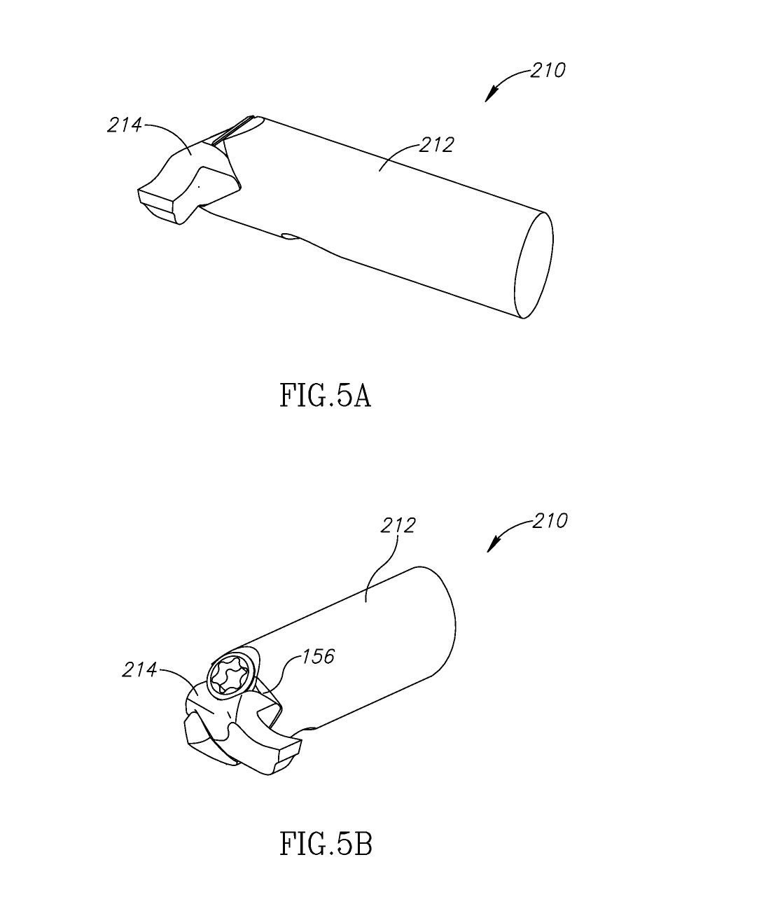

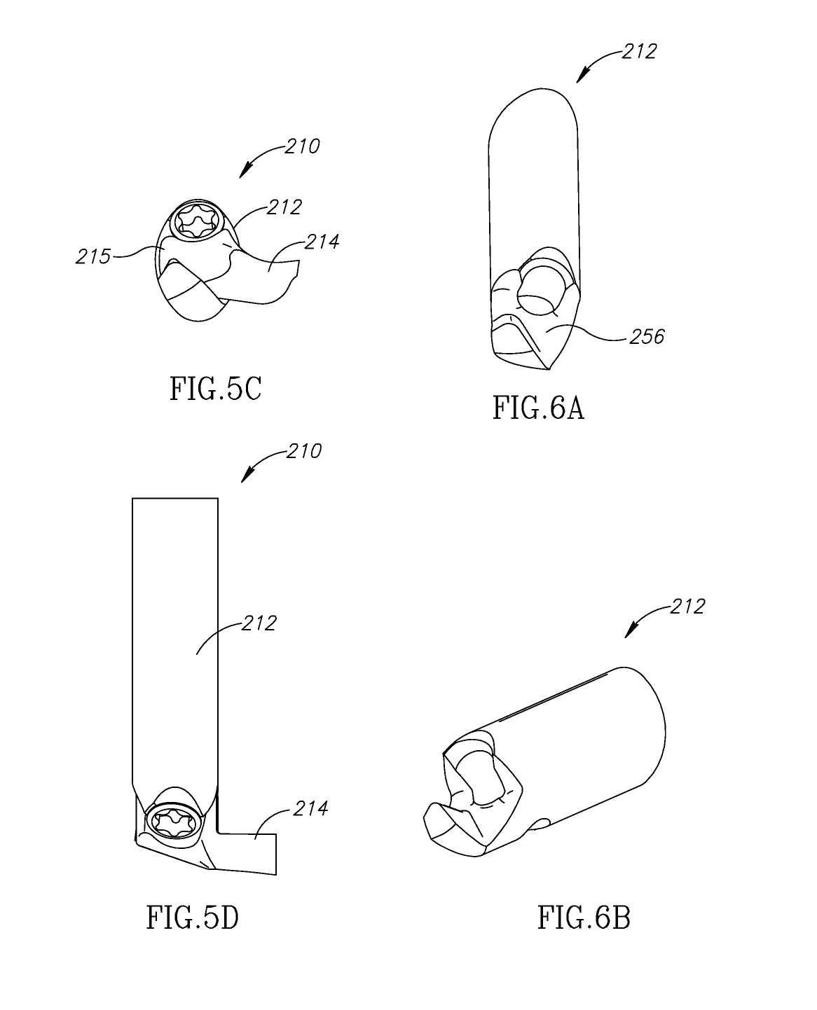

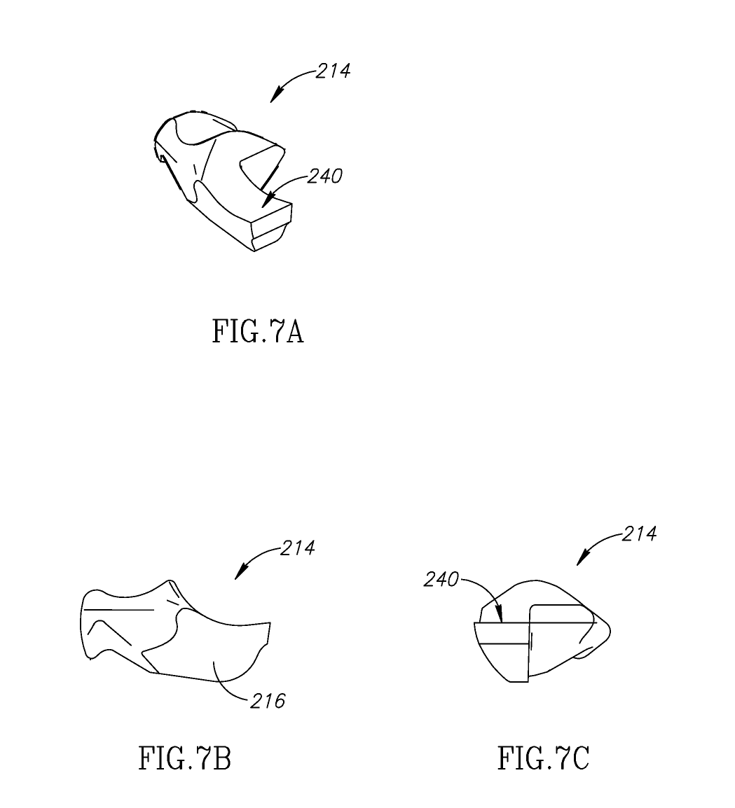

Drawing attention to FIGS. 5 to 7, it will be understood that the advantageous mounting features above can also be potentially beneficial for a cutting insert 214 with only a single cutting portion 216 and single rake surface 240. Tool assembly 210 is shown, with elements similar to those mentioned above in connection with tool assembly 10, albeit having reference numerals shifted by 200.

While the tool 212 is substantially similar to tool 12, it will be understood that the insert pocket 156 can be free of features associated with additional cutting portions (e.g. at least elongated peripheral portions of the first and second pocket portions 80A, 80B, and tool guard portions 82, 84).

Differences relating to the cutting insert 214 can be that it can be straight and can be free of contoured surfaces. Nonetheless it can comprise an extension portion 215 (FIG. 5C), which comprises one of the anchoring surfaces, to complete the wedge construction.

Accordingly, it will be understood that the subject matter of the present application can relate to cutting inserts having one or more cutting portions and that the cutting portion(s) can be oriented to cut in a desired direction, per application.

The description above includes exemplary embodiments and details for enablement, if needed, of claimed subject matter, and does not exclude non-exemplified embodiments and details from the claim scope of the present application.

What is claimed is:

1. A cutting insert having an insert plane which is parallel to a largest imaginary circle that circumscribes the cutting insert, the cutting insert comprising
an insert mounting portion, and
a plurality of non-parallel cutting fingers, each of which projects from the insert mounting portion and comprises a cutting edge extending between a rake surface and at least one relief surface;
wherein each rake surface is slanted relative to the insert plane.

2. The cutting insert according to claim 1, wherein each of the cutting fingers is elongated.

3. The cutting insert according to claim 1, wherein the insert mounting portion comprises a plurality of insert mounting projections, each cutting finger projecting from an associated mounting projection and forming a bend therewith.

4. The cutting insert according to claim 1, wherein, in a plan view of the rake surface of one of the cutting fingers, the cutting insert is non-planar along planes parallel and perpendicular to the rake surface viewed.

5. The cutting insert according to claim 1, wherein, in a Cartesian coordinate system, when a first one of cutting fingers projects parallel with, and in a positive direction along, a z-axis: one of the other cutting fingers extends at least in a positive direction of an axis which is not the z-axis, and another of the other cutting fingers extends at least in a negative direction of the same axis.

6. The cutting insert according to claim 5, wherein one of the two cutting fingers, which is not the first cutting finger, projects in the negative direction of each of the x, y and z axes.

7. The cutting insert according to claim 6, wherein another of the two cutting fingers, which is not the first cutting finger, projects in the positive direction of the x and y axes and the negative direction of the z-axis.

8. The cutting insert according to claim 5, wherein the arrangement described is true in a plan, side and end rake surface view of the first cutting finger.

9. The cutting insert according to claim 1, wherein the at least one relief surface is contoured such that, with the exception of one of the cutting fingers, the remainder of the cutting insert is shaped to remain within a volume periphery of regular volumetric shape.

10. The cutting insert according to claim 9, wherein the volume periphery is curved.

11. The cutting insert according to claim 9, wherein each cutting finger has at least two differently located and/or shaped contoured relief surfaces, and wherein a contoured relief surface of one cutting finger is configured to complement a different contoured relief surface of another cutting finger for remaining with the volume periphery.

12. The cutting insert according to claim 1, wherein the insert mounting portion is solid.

13. The cutting insert according to claim 12, wherein the insert mounting portion comprises an insert anchoring arrangement;
the insert anchoring arrangement comprising
an insert base surface, and
first and second insert anchoring surfaces which are adjacent to each other and extend transversely to each other and to the insert base surface.

14. The cutting insert according to claim 13, wherein the first and second insert anchoring surfaces form an external angle of between 40° to 140°.

15. The cutting insert according to claim 13, further comprising a concavely-shaped insert biasing portion which is spaced apart from the insert anchoring arrangement.

16. A tool comprising:
a clamping arrangement,
a tool anchoring arrangement, and
an insert pocket comprising a neck portion located between the clamping arrangement and the tool anchoring arrangement, and first and second pocket portions which are located on opposite sides of, and expand from, the neck portion.

17. The tool according to claim 16, wherein the tool anchoring arrangement comprises a tool base surface, and first and second tool anchoring surfaces extending transversely relative to each other and to the tool base surface.

18. The tool according to claim 17, wherein the tool anchoring arrangement extends axially along the tool further outward from the tool than the clamping arrangement and is thereby configured to guide a cutting insert from the first and second insert anchoring surfaces to the tool base surface.

19. The tool according to claim 17, wherein the tool base surface extends slanted relative to a first tool plane extending longitudinally through the tool, and a second tool plane perpendicular to the first tool plane.

20. The tool according to claim 16, wherein the first and second pocket portions are located at opposite sides of the tool.

21. The tool according to claim 16, wherein the insert pocket extends through a center of the tool.

22. The tool according to claim 16, wherein the first and second pocket portions extend in different axial directions along a longitudinal axis of the tool.

23. A tool assembly comprising
a cutting insert comprising an insert mounting portion and a plurality of cutting fingers projecting from the insert mounting portion, and
a tool configured to hold the cutting insert;
the tool comprising
a clamping arrangement, and
an insert pocket formed at, at least, a central portion of the tool; and
wherein, in an end view of the tool assembly when the cutting insert is mounted in the insert pocket, exactly one of the plurality of cutting fingers of the cutting insert is the only part of the cutting insert to project from a periphery of the tool.

24. The tool assembly according to claim 23, wherein an imaginary circle circumscribing a largest dimension of the cutting insert has an insert diameter larger than a dimension taken along a cross section of the tool in an end view thereof.
